(19) United States
(12) Patent Application Publication
(10) Pub. No.: US 2020/0224601 A1
(43) Pub. Date: Jul. 16, 2020

(54) METHOD OF DIAGNOSING A PROPULSION SYSTEM OF A VEHICLE, AND A SYSTEM THEREFOR

(71) Applicant: GM Global Technology Operations LLC, Detroit, MI (US)

(72) Inventors: Ibrahim Haskara, Macomb, MI (US); Chen-fang Chang, Bloomfield Hills, MI (US); Shiming Duan, Ann Arbor, MI (US); Chunhao J. Lee, Troy, MI (US); Azeem Sarwar, Rochester Hills, MI (US)

(73) Assignee: GM Global Technology Operations LLC, Detroit, MI (US)

(21) Appl. No.: 16/247,746

(22) Filed: Jan. 15, 2019

(51) Int. Cl. F02D 41/22; G07C 5/08; F02D 11/10

(52) U.S. Cl. CPC F02D 41/22; F02D 41/26; F02D 11/107; G07C 5/0808

(57) ABSTRACT

A method of diagnosing a propulsion system implements a top-down hierarchical examination procedure, in which the propulsion system is analyzed as a whole to determine if the propulsion system is healthy. Data from a first set of vehicle sensors is compared to a system-healthy data cluster to determine if the propulsion system is healthy or unhealthy. If the propulsion system is unhealthy, then a plurality of subsystems of the propulsion system are each analyzed at a first examination level using selective data from the sensors to identify one of the subsystems as an unhealthy subsystem. A plurality of component systems of the unhealthy subsystem are then analyzed at a second examination level using other selective data from the sensors to identify one of the component systems of the unhealthy subsystem as an unhealthy component system.

### INTRODUCTION

The disclosure generally relates to a method of diagnosing a propulsion system of a vehicle, and a diagnostic system therefor.

A propulsion system for a vehicle includes many different subsystems, with each subsystem having several different components. Each individual component of one of the subsystems may additionally have several sub-components. The vehicle includes many different sensors for sensing data related to the operation of the propulsion system. The vehicle may run an individual diagnostic test for many of the different components/sub-components of the different subsystems in order to determine if the components/sub-components are operating properly, i.e., healthy, or if they are not operating properly, i.e., unhealthy. This constitutes a bottom-up strategy, in which each component/subcomponent of the propulsion system is analyzed with a respective diagnostic test to determine the health of that respective component/subcomponent.

### SUMMARY

A method of diagnosing a propulsion system of a vehicle is provided. The method includes defining a first set of a plurality of sensors of the vehicle for evaluating an overall status of the propulsion system. A system-healthy data cluster is defined, and saved on a memory of a computing device of the vehicle. The system-healthy data cluster defines an inclusive range of data values from the first set of the plurality of sensors indicating a healthy status of the propulsion system. Data from the first set of the plurality of sensors is sensed. The computing device compares the data sensed from the first set of the plurality of sensors to the system-healthy data cluster to determine if the data sensed from the first set of the plurality of sensors is within the system-healthy data cluster, or if the data sensed from the first set of the plurality of sensors is at least partially outside the system-healthy data cluster. When the data sensed from the first set of the plurality of sensors is at least partially outside the system-healthy data cluster, then the computing device indicates that the propulsion system is unhealthy. When the propulsion system is unhealthy, the computing system analyzes the propulsion system using a top-down hierarchical examination procedure, in which a plurality of subsystems of the propulsion system are analyzed at a first examination level using selective data from the plurality of sensors to identify one of the plurality of subsystems as an unhealthy subsystem, and then a plurality of component systems of the unhealthy subsystem are analyzed at a second examination level using other selective data from the plurality of sensors to identify one of the plurality of component systems as an unhealthy component system.

In one aspect of the method of diagnosing the propulsion system, the plurality of subsystems of the propulsion system includes a first subsystem. The computing device analyzes the propulsion system using the top-down hierarchical examination procedure by determining if the first subsystem of the propulsion system is the unhealthy subsystem, based on the data sensed from the first set of the plurality of sensors. The computing device may further determine if a second subsystem, a third subsystem, etc., of the propulsion system are unhealthy subsystems, based on the data sensed from the first set of the plurality of sensors.

In one aspect of the method of diagnosing the propulsion system, a first subsystem-status data cluster for the first subsystem is defined, and saved in the memory of the computing device. The first subsystem-status data cluster defines a range of data values from the first set of the plurality of sensors indicating that the first subsystem is the unhealthy subsystem. The computing device may then compare the data sensed from the first set of the plurality of sensors to the first subsystem-status data cluster, to determine if the data sensed from the first set of the plurality of sensors is within the first subsystem-status data cluster, or if the data sensed from the first set of the plurality of sensors is outside the first subsystem-status data cluster. When the data sensed from the first set of the plurality of sensors is inside of the first subsystem-status data cluster, the computing device may then indicate that the first subsystem is the unhealthy subsystem.

In one aspect of the method of diagnosing the propulsion system, the plurality of components of the first subsystem includes a first component system. A first component-status data cluster for the first component system of the first subsystem is defined, and saved in the memory of the computing device. The first component-status data cluster defines a range of data values from a second set of the plurality of sensors indicating that the first component system of the first subsystem is the unhealthy component system. When the first subsystem is the unhealthy subsystem, the computing device compares data sensed from the second set of the plurality of sensors to the first component-status data cluster to determine if the data sensed from the second set of the plurality of sensors is within the first component-status data cluster, or if the data sensed from the second set of the plurality of sensors is outside the first component-status data cluster. When the data sensed from the second set of the plurality of sensors is inside of the first component-status data cluster, then the computing device indicates that the first component system of the first subsystem is the unhealthy component system.

In one aspect of the method of diagnosing the propulsion system, the method is characterized by the top-down hierarchical examination procedure, which examines the subsystems and components of the subsystem in a top-down order to identify the root cause of the unhealthy system. By so doing, the process described herein does not perform additional diagnostic tests on the plurality of subsystems and on the plurality of components of each of the plurality of subsystems, when the data sensed from the first set of the plurality of sensors is inside the system-healthy data cluster. In other words, if the propulsion system is healthy, i.e., the data sensed from the first set of the plurality of sensors is within the system-healthy data cluster, then the process does not perform additional diagnostic tests, thereby reducing the computational demands on the computing device and improving the efficiency of the diagnostic system.

In one aspect of the method of diagnosing the propulsion system, the computing device may manipulate the data sensed from the first set of the plurality of sensors to define a data value. The computing device may then use the data value to compare to the system-healthy data cluster to determine if the data sensed from the first set of the plurality of sensors is within the system-healthy data cluster, or if the data sensed from the first set of the plurality of sensors is outside the system-healthy data cluster. The data value may be calculated or defined for a period of time to define a running average, or to define multiple independent data values.

A vehicle is also provided. The vehicle includes a propulsion system having a plurality of subsystems. Each of the plurality of subsystems may include a plurality of components. The vehicle includes a plurality of sensors that are operable to sense data related to operation of the propulsion system. A diagnostic system is disposed in communication with the plurality of sensors, and is operable to receive data from the plurality of sensors. The diagnostic system includes a processor, and a memory having a system-healthy data cluster, and a diagnostic algorithm stored thereon. The processor is operable to execute the diagnostic algorithm to implement a method of diagnosing the propulsion system. More particularly, the processor executes the diagnostic algorithm to sense data from a first set of the plurality of sensors. The data sensed from the first set of the plurality of sensors is compared to the system-healthy data cluster to determine if the data sensed from the first set of the plurality of sensors is within the system-healthy data cluster, or if the data sensed from the first set of the plurality of sensors is outside the system-healthy data cluster. The system-healthy data cluster defines an inclusive range of data values from the first set of the plurality of sensors indicating a healthy status of the propulsion system. When the data sensed from the first set of the plurality of sensors is outside the system-healthy data cluster, the diagnostic algorithm indicates that the propulsion system is unhealthy, and proceeds to analyze the propulsion system using a top-down hierarchical examination procedure. The top-down hierarchical examination procedure analyzes a plurality of subsystems of the propulsion system at a first examination level using selective data from the plurality of sensors to identify one of the plurality of subsystems as an unhealthy subsystem, and then a plurality of component systems of the unhealthy subsystem are analyzed at a second examination level using other selective data from the plurality of sensors to identify one of the plurality of component systems as an unhealthy component system.

In one aspect of the vehicle, a first subsystem-status data cluster is saved on the memory of the computing device. The first subsystem-status data cluster defines a range of data values from the first set of the plurality of sensors indicating that a first subsystem of the propulsion system is the unhealthy subsystem. The processor is operable to execute the diagnostic algorithm to compare data sensed from the first set of the plurality of sensors to the first subsystem-status data cluster to determine if the data sensed from the first set of the plurality of sensors is within the first subsystem-status data cluster, or if the data sensed from the first set of the plurality of sensors is outside the first subsystem-status data cluster. The diagnostic algorithm may indicate that the first subsystem is the unhealthy subsystem when the data sensed from the first set of the plurality of sensors is inside of the first subsystem-status data cluster.

In another aspect of the vehicle, a first component-status data cluster is saved on the memory of the computing device. The first component-status data cluster defines a range of data values from a second set of the plurality of sensors indicating that a first component system of the first subsystem is the unhealthy component system. When the first subsystem is the unhealthy subsystem the processor is operable to execute the diagnostic algorithm to compare data sensed from the second set of the plurality of sensors to the first component-status data cluster, to determine if the data sensed from the second set of the plurality of sensors is within the first component-status data cluster, or if the data sensed from the second set of the plurality of sensors is outside the first component-status data cluster. When the data sensed from the second set of the plurality of sensors is inside of the first component-status data cluster, the diagnostic algorithm may indicate that the first component system of the first subsystem is the unhealthy component system.

Accordingly, the diagnostic algorithm may identify the root cause, i.e., the unhealthy subcomponent of one of the component systems of one of the subsystems of the propulsion system, causing the propulsion system to operate outside of the system-healthy cluster, i.e., range. By using the top-down hierarchical examination procedure, computational requirements on the computing device are minimized, because the diagnostic system does not have to examine each and every component and subcomponent of the propulsion system. This is because the top-down hierarchical examination procedure does not examine or analyze the subcomponents, component systems, and/or the subsystems of the propulsion system that are healthy.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a vehicle.

FIG. 2 is a flow diagram illustrating a top-down hierarchical examination procedure of a diagnostic system of the vehicle.

FIG. 3 is a schematic graph showing a system-healthy and subsystem-unhealthy data cluster boundaries.

FIG. 4 is a schematic graph showing component-unhealthy data cluster boundaries.

FIG. 5 is a flow chart illustrating a method of diagnosing a propulsion system of the vehicle.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

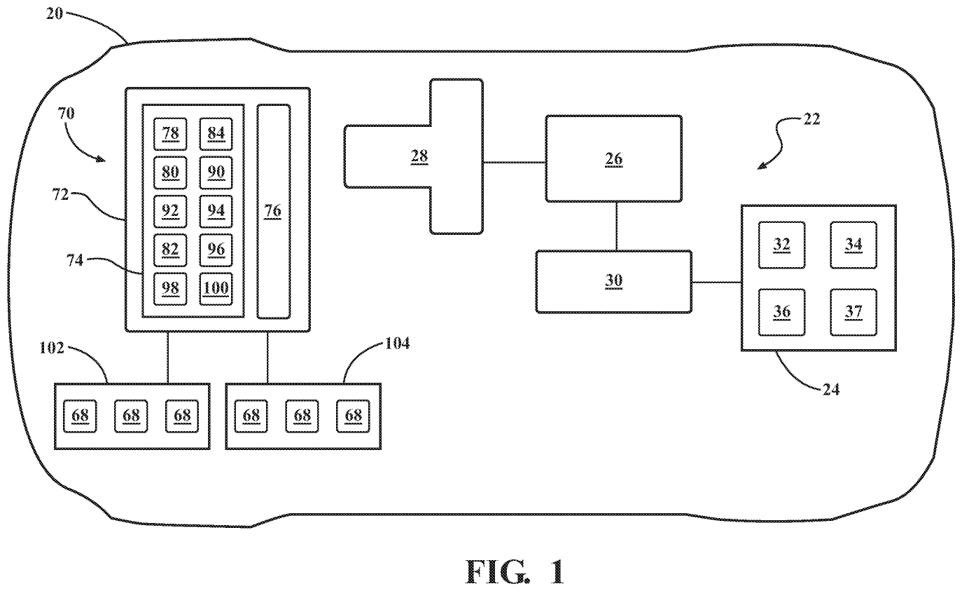

Referring to the FIGS., wherein like numerals indicate like parts throughout the several views, a vehicle is generally shown at 20 in FIG. 1. Referring to FIG. 1, the vehicle 20 may include a type of moveable platform, such as but not limited to a car, a truck, a van, a tractor, a boat, a plane, an ATV, a UTV, etc. The vehicle 20 includes a propulsion system 22. The propulsion system 22 may include, but is not limited to, an internal combustion engine 24, an electric motor 26, an energy storage device 28, e.g., a battery, a transmission 30, a transfer case (not shown), one or more drive axles (not shown), a differential gear set (not shown), a wheel braking system (not shown), a fuel system 32, an air intake system 34, an exhaust system 36, an ignition system 37, etc. The propulsion system 22 may be configured with just the internal combustion engine 24 to provide propulsive power for the vehicle 20, just the electric motor 26 to provide propulsive power for the vehicle 20, a combination of the internal combustion engine 24 and the electric motor 26 to provide propulsive power for the vehicle 20, or some other combination of components and systems not described herein that provide the propulsive power for the vehicle 20. As shown in the Figures and described herein, the propulsion system 22 is embodied as a hybrid system having both the internal combustion engine 24 and the electric motor 26. However, the teachings of this disclosure are not limited to the exemplary hybrid system shown and described herein.

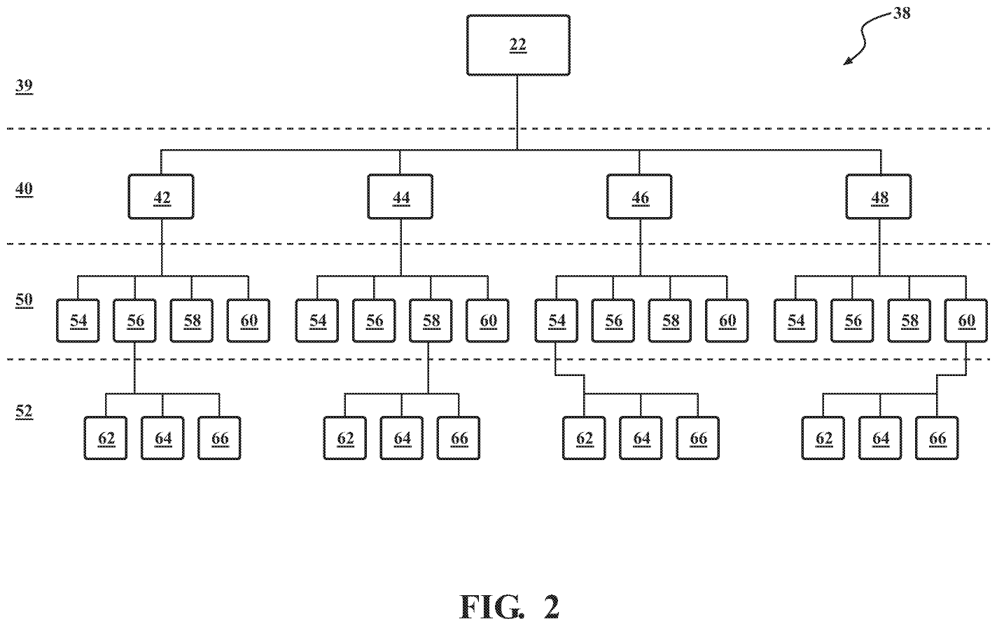

Referring to FIG. 2, the propulsion system 22, however configured, includes a plurality of subsystems 42, 44, 46, 48. As shown in FIG. 2, the propulsion system 22 is generally shown at the top or highest level 39 of a hierarchical structure 38. Below the propulsion system 22, at a first level 40 of the hierarchical structure 38, the subsystems 42, 44, 46, 48 of the propulsion system 22 are generally shown. The specific number and type of subsystems included in the propulsion system 22 vary with the type and configuration of the propulsion system 22. Propulsion systems 22 configured differently than the exemplary embodiment described herein and shown in FIG. 1 will include different subsystems. The subsystems 42, 44, 46, 48 of the exemplary propulsion system 22 may include, but are not limited to, the internal combustion engine 24, the transmission 30, the electric motor 26, and the energy storage device 28. The subsystems may be defined based on a particular function provided to the overall operation of the propulsion system 22.

As noted above, the subsystems of the propulsion system 22 may differ from the exemplary subsystems 42, 44, 46, 48 described herein, and generally shown on the first level 40 of the hierarchical structure 38 of the propulsion system 22. As such, the subsystems of the propulsion system 22 may be described as a first subsystem 42, a second subsystem 44, a third subsystem 46, a fourth subsystem 48, etc. The first subsystem 42 may be defined to include one of the subsystems of the propulsion system 22. The second subsystem 44 may be defined to include one of the remaining subsystems of the propulsion system 22, and so on. As such, the first subsystem 42 is used herein to generically refer to one of the subsystems of the propulsion system 22. As such, as used herein with reference to the exemplary embodiment shown in FIG. 1, the first subsystem 42 may be defined to include one of the internal combustion engine 24, the transmission 30, the electric motor 26, or the energy storage device 28. The second subsystem 44 is used herein to generically refer to one of the remaining subsystems of the propulsion system 22 not defined as the first subsystem 42.

Each of the individual subsystems 42, 44, 46, 48 may further include one or more component systems 54, 56, 58, 60. As shown in FIG. 2, the different component systems 54, 56, 58, 60 for each subsystem are generally shown at a second level 50 of the hierarchical structure 38. For example, the component systems 54, 56, 58, 60 of the internal combustion engine 24 may include the air intake system 34, the fuel system 32, the exhaust system 36, the ignition system 37, etc. Each of the component systems 54, 56, 58, 60 of each respective subsystem 42, 44, 46, 48 may further include one or more subcomponents 62, 64, 66. As shown in FIG. 2, the different subcomponents 62, 64, 66 for each component system 54, 56, 58, 60 are generally shown at a third level 52 of the hierarchical structure 38. For example, the fuel system 32 of the internal combustion engine 24 may include subcomponents including, but not limited to, a fuel pump (not shown), a fuel filter (not shown), fuel injectors (not shown), etc. The air intake system 34 of the internal combustion engine 24 may include subcomponents including, but not limited to, an air filter (not shown), a throttle (not shown), etc. The propulsion system 22 may be further decomposed into additional levels of the hierarchical structure 38. Accordingly, it should be understood that the teachings of the disclosure are not limited to the exemplary hierarchical structure 38 shown in FIG. 2 and described herein.

As noted above, the component systems 54, 56, 58, 60 of each respective subsystem 42, 44, 46, 48 may differ from the exemplary component systems described herein, and generally shown on the second level 50 of the hierarchical structure 38 of the propulsion system 22. As such, the component systems of each respective subsystem may be described as a first component system 54, a second component system 56, a third component system 58, a fourth component system 60, etc. The first component system 54 may be defined to include one of the component systems of its' respective subsystem. The second component system 56 may be defined to include one of the remaining component systems of its respective subsystem, and so on. The first component system 54 is used herein to generically refer to one of the component systems of the first subsystem 42. As such, as used herein with reference to the exemplary embodiment shown in FIG. 1, if the first subsystem 42 is defined to include the internal combustion engine 24, then the first component system 54 may be defined to include one of the intake air system, the fuel supply system, the exhaust system 36, or the ignition system 37.

Similarly, as noted above, the subcomponents of each respective component system may differ from the exemplary subcomponents described herein, and generally shown on the third level 52 of the hierarchical structure 38 of the propulsion system 22. As such, the subcomponents of each respective component system may be described as a first subcomponent 62, a second subcomponent 64, a third subcomponent 66, etc. The first subcomponent 62 may be defined to include one of the components of its' respective component system. The second subcomponent 64 may be defined to include one of the remaining components of its' respective component system, and so on. As such, the first subcomponent 62 is used herein to generically refer to one of the subcomponents of the first component system 54.

Referring to FIG. 1, the vehicle 20 further includes a plurality of sensors 68. The sensors 68 are operable to sense data related to the operation of the propulsion system 22. The sensors 68 may be configured to sense data needed to assess the operation of the propulsion system 22. The specific type, configuration, and number of sensors 68 will vary with different configurations of the propulsion system 22. As such, the sensors 68 may sense data related to rotational speed of a feature, e.g., a crankshaft or transmission shaft, torque, air flow, oxygen levels, electric voltage levels, electric current levels, acceleration levels, fluid levels, etc. Each sensor 68 provides a data stream related to a particular type of data for a feature of the propulsion system 22. As such, the plurality of sensors 68, as a whole, provide several different types of data for several different aspects of the operation of the propulsion system 22. The specific types of data provided by the sensors 68, and the specific type and operation of the sensors 68, is not pertinent to the teachings of this disclosure, are understood by those skilled in the art, and are therefore not described in detail herein.

The vehicle 20 further includes a diagnostic system 70. The diagnostic system 70 is disposed in communication with the sensors 68, and is operable to receive data from the sensors 68. The diagnostic system 70 includes a computing device 72 having a memory 74 and a processor 76. The memory 74 of the computing device 72 includes a system-healthy data cluster 78, a first subsystem-status data cluster 80 for the first subsystem 42, a first component-status data cluster 82, and a diagnostic algorithm 84 stored thereon.

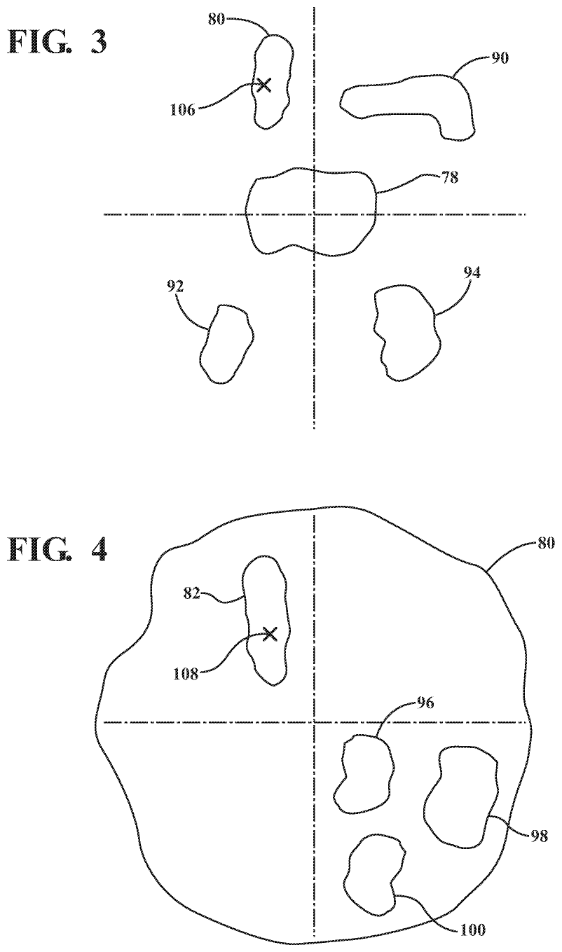

Referring to FIG. 3, the system-healthy data cluster 78 defines an inclusive range of data values for a first set 102 of the sensors 68. Data points obtained and/or processed from the data values from the first set 102 of the sensors 68 that are within the inclusive range of the system-healthy data cluster 78 indicate that the propulsion system 22 is healthy, whereas data points obtained and/or processed from the data values from the first set 102 of the sensors 68 that are outside the inclusive range of the system-healthy data cluster 78 indicate that the propulsion system 22 is unhealthy. Because data from one or more of the sensors 68 may be used to analyze a specific subcomponent of one of the component systems, and may not be required to determine the overall health of the propulsion system 22, the first set 102 of the sensors 68 includes a defined subset of the available sensors 68 of the vehicle 20. As such, the first set 102 of the sensors 68 does not include each of the available sensors 68.

The first set 102 of the sensors 68 includes a minimal number of sensors 68 to provide the minimal data to describe the healthy/unhealthy state of the propulsion system 22, and if the propulsion system 22 is unhealthy, identify which subsystem 42, 44, 46, 48 is unhealthy. Some data may be used and/or processed to define derived variables of sensor measurements that describe the healthy/unhealthy state of the propulsion system 22, e.g., the system-healthy data cluster 78. For example, the variables associated with the healthy/unhealthy state of the internal combustion engine 24 may include an engine torque/speed output in response to defined inputs, e.g., throttle angle, fuel pulse-width, etc. A model of the engine torque generation may be used to compute an error between the expected torque and measured torque. This error signal may be used to determine if the internal combustion engine 24 is developing the right amount of torque, i.e., is healthy, or not. In other words, the error signal is the data compared to the system-healthy data cluster 78. Similarly, the air intake system may be evaluated with respect to a fresh air amount delivered into the combustion chamber by blending a sensor measure with a model generating the expected air amount. The top-down hierarchical structure 38 enables the use of key variables/data measurements to check the operation of a particular system, subsystem or component, thereby minimizing the number of sensors 68 required to evaluate each system, subsystem, or component.

The first subsystem-status data cluster 80 may include a range that defines a healthy status or an unhealthy status. The range may be inclusive, or exclusive. As described herein, the first subsystem-status data cluster 80 is described as the first subsystem-status unhealthy data cluster 80. The first subsystem-unhealthy data cluster 80 defines a range of data values from the first set 102 of the sensors 68. Data points obtained and/or processed from the data values from the first set 102 of the sensors 68 that are within the inclusive range of the first subsystem-unhealthy data cluster 80 indicate that the first subsystem 42 is unhealthy. Data points obtained and/or processed from the data values from the first set 102 of the sensors 68 that are outside the inclusive range of the first subsystem-unhealthy data cluster 80 are inconclusive as to the health of the first subsystem 42.

The first component-status data cluster 82 may include a range that defines a healthy status or an unhealthy status. The range may be inclusive, or exclusive. As described herein, the first component-status data cluster 82 is described as the first component-status unhealthy data cluster 82. The first component-unhealthy data cluster 82 defines a range of data values from a second set 104 of the sensors 68. Data points obtained and/or processed from the data values from the second set 104 of the sensors 68 that are within the inclusive range of the first component-unhealthy data cluster 82 indicate that the first component system 54 of the first subsystem 42 is unhealthy. Data points obtained and/or processed from the data values from the second set 104 of the sensors 68 that are outside the inclusive range of the first component-unhealthy data cluster 82 are inconclusive as to the health of the first component system 54.

Because data from one or more of the sensors 68 may be used to analyze a specific subcomponent of the first component system 54, or a different component system, e.g., the second component system 56, the data from one or more of the sensors 68 may not be required to determine the overall health of the first component system 54. As such, the second set 104 of the sensors 68 includes a defined subset of the available sensors 68 of the vehicle 20. As such, the second set 104 of the sensors 68 does not include each of the available sensors 68. Additionally, the sensors 68 included in the second set 104 of the sensors 68 may differ from the sensors 68 included in the first set 102 of the sensors 68. The second set 104 of the sensors 68 includes a minimal number of sensors 68 to provide the minimal data to describe the healthy/unhealthy state of the first component system 54. Some data may be used and/or processed to define derived variables of sensor measurements that describe the healthy/unhealthy state of the first component system 54, e.g., the first component un-healthy data cluster 82.

The subsystem-unhealthy data clusters and the component-unhealthy data clusters described herein may be considered to define a specific failure mode of hardware for a given subsystem or component. For example, different failure modes may result in the fuel system 32 being unhealthy. The different failure modes for the fuel system 32 may include, but are not limited to, a fuel injector leak causing over fueling or a fuel injector clog causing under fueling. Although both of these failure modes are related to the same hardware, i.e., a fuel injector, each of these different failure modes may include a respective component-unhealthy data cluster to define each respective failure mode. As such, it should be appreciated that each subsystem-unhealthy data cluster and/or each component-unhealthy data cluster may define a specific failure mode. Furthermore, it should be appreciated that the number of subsystem-unhealthy data clusters and component-unhealthy data clusters may vary from the exemplary embodiments described herein.

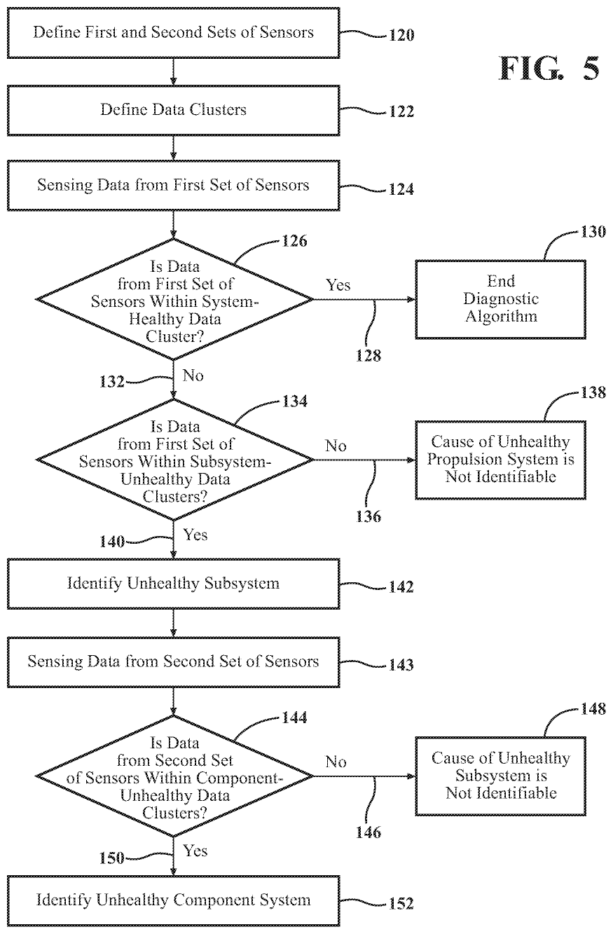

The computing device 72 may be referred to as a computer, a control module, a control unit, a vehicle controller, a controller, etc. The computing device 72 analyzes the data obtained by the sensors 68 to diagnose the health of the propulsion system 22. As noted above, the computing device 72 includes the memory 74 and the processor 76. Additionally, the computing device 72 may include other software, hardware, memory, algorithms, connections, sensors, etc., to diagnose the health of the propulsion system 22. As such, a method, described below and generally shown in FIG. 5, may be embodied as a program or algorithm at least partially operable on the computing device 72. It should be appreciated that the computing device 72 may include a device capable of analyzing data from the various sensors 68, comparing the data, and making the decisions required to diagnose the health of the propulsion system 22.

Additionally, the computing device 72 may include a communication link to an off-vehicle server or computer, and/or be configured for processing data in the Cloud as is understood by those in the art. As such, data from the vehicle may be communicated to an off-vehicle computer or system, so that at least some of the processes of the algorithm described herein may be performed on computers or systems located off-vehicle and/or in the Cloud. For example, certain data from a set of the sensors, or variables calculated from sensor data, may be communicated to the Cloud, whereupon the communicated data may be processed and analyzed and the results communicated back to the computing device 72 of the vehicle 20, to another data processing center, or to a service facility. As such, it should be appreciated that some aspects of the algorithm described herein may be executed onboard the vehicle 20 by the computing device 72, or may be executed offboard the vehicle 20 by another computer programmed to execute the specific processes. As such, while the disclosure generally describes the computing device 72 of the vehicle executing the diagnostic algorithm 84 described herein, it should be appreciated that the scope of the disclosure is not limited to the computing device 72 of the vehicle 20 executing the entirety of the described diagnostic algorithm 84, and that the scope of the disclosure includes using off vehicle systems for executing one or more aspects of the diagnostic algorithm 84. As such, the computing device 72 may be interpreted broadly to include other computing systems located remote from the vehicle 20, but that are connected to the computing device 72 on the vehicle for communication therebetween.

The computing device 72 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, input/output (I/O) circuitry, I/O devices, and communication interfaces, as well as signal conditioning and buffer electronics.

The computer-readable memory 74 may include non-transitory/tangible medium which participates in providing data or computer-readable instructions. Memory 74 may be non-volatile or volatile. Non-volatile media may include, for example, optical or magnetic disks and other persistent memory. Example volatile media may include dynamic random access memory (DRAM), which may constitute a main memory. Other examples of embodiments for the memory 74 include a floppy, flexible disk, or hard disk, magnetic tape or other magnetic medium, a CD-ROM, DVD, and/or other optical medium, as well as other possible memory devices such as flash memory.

The computing device 72 includes the tangible, non-transitory memory 74 on which are recorded computer-executable instructions, including the diagnostic algorithm 70. The processor 76 of the computing device 72 is configured for executing the diagnostic algorithm 70. The diagnostic algorithm 70 implements a method of diagnosing the propulsion system 22 of the vehicle 20.

Referring to FIG. 5, the method includes defining the first set 102 of the sensors 68 of the vehicle 20 for evaluating an overall health of the propulsion system 22, and defining the second set 104 of the sensors 68 for evaluating the health of the component systems 54, 56, 58, 60. The steps of defining the first set 102 and the second set 104 of the sensors 68 is generally indicated by box 120 in FIG. 5. As noted above, the vehicle 20 includes the plurality of sensors 68, with each sensor 68 operable to sense data related to a certain function or operation. The first set 102 of the sensors 68 includes the sensors 68 that are needed to evaluate the overall status of the propulsion system 22. The specific data needed to evaluate the overall health of the propulsion system 22 is dependent upon the specific configuration and features of the propulsion system 22. In addition, the first set 102 of the sensors 68 may include the sensors 68 that are needed to evaluate the health of the first subsystem 42 of the propulsion system 22. The specific data needed to evaluate the health of the first subsystem 42 is dependent upon the specific operation and/or function of the first subsystem 42.

Similarly, the second set 104 of the sensors 68 of the vehicle 20 for evaluating the component systems 54, 56, 58, 60 of the first subsystem 42 is also defined. As noted above, the vehicle 20 includes the plurality of sensors 68, with each sensor 68 operable to sense data related to a certain function or operation. The second set 104 of the sensors 68 includes those sensors 68 that are needed to evaluate the health of the first component system 54. The specific data needed to evaluate the health of the propulsion system 22 is dependent upon the specific operation and/or function of the first component system 54.

The system-healthy data cluster 78 for evaluating the overall health of the propulsion system 22, the first subsystem-unhealthy data cluster 80 for determining if the first subsystem 42 is unhealthy, and the first component-unhealthy data cluster 82 for determining if the first component system 54 of the first subsystem 42 is unhealthy are also defined, and saved in the memory 74 of the computing device 72. The step of defining the data clusters for the diagnostic system 70 is generally indicated by box 122 in FIG. 5. The system-healthy data cluster 78 may be defined by examining certain data from certain sensors 68 of the vehicle 20 when the propulsion system 22 is appreciated to be operating properly, i.e., healthy. By looking at the data from the select sensors 68 of the understood to be healthy propulsion system 22, the range of values of the data may be defined to establish the system-healthy data cluster 78 for the propulsion system 22. It should be appreciated that data from the available sensors 68 is not required to evaluate the overall operational health of the propulsion system 22, which is why the first set 102 of the sensors 68 includes a selection of the available sensors 68.

The first subsystem-unhealthy data cluster 80 may be defined by examining certain data from certain sensors 68 of the vehicle 20 when the first subsystem 42 is appreciated to be operating improperly, i.e., unhealthy. By looking at the data from the select sensors 68 of the appreciated unhealthy first subsystem 42, the range of values of the data may be defined to establish the first subsystem-unhealthy data cluster 80. It should be appreciated that data from the available sensors 68 is not required to evaluate the overall operational health of the first subsystem 42, which is why the first set 102 of the sensors 68 includes a selection of the available sensors 68.

The first component-unhealthy data cluster 82 may be defined by examining certain data from certain sensors 68 of the vehicle 20 when the first component system 54 is appreciated to be operating improperly, i.e., unhealthy. By looking at the data from the select sensors 68 of the appreciated unhealthy first component system 54, the range of values of the data may be defined to establish the first component-unhealthy data cluster 82. It should be appreciated that data from the available sensors 68 is not required to evaluate the overall operational health of the first component system 54, which is why the second set 104 of the sensors 68 includes a selection of the available sensors 68.

Data from the first set 102 of the sensors 68 is sensed, and communicated to the computing device 72. The step of sensing data with the first set 102 of sensors 68 is generally indicated by box 124 in FIG. 5. As noted above, the specific type of data and the specific type of sensors 68 used to obtain the data is dependent upon the specific configuration of the propulsion system 22. The computing device 72 may, in some circumstances, manipulate the data sensed from the first set 102 of the sensors 68 to define one or more data values. The data values may then be compared to the system-healthy data cluster 78, and/or the first subsystem-unhealthy data cluster 80 respectively. The data values may represent computational or functional values that are used to evaluate the propulsion system 22 and/or the first subsystem 42. As such, it should be appreciated that the data directly from the sensors 68, or data values calculated from the data directly obtained from the sensors 68, may be used by the diagnostic algorithm 70 to determine the health of the propulsion system 22.

Once the data from the first set 102 of the sensors 68 has been obtained, then the diagnostic algorithm 70 may compare the data sensed from the first set 102 of the sensors 68 to the system-healthy data cluster 78. The step of comparing the sensed data from the first set 102 of the sensors 68 to the system-healthy data cluster 78 is generally indicated by box 126 in FIG. 5 The diagnostic algorithm 70 makes this comparison to determine if the data sensed from the first set 102 of the sensors 68 is within the system-healthy data cluster 78, or if the data sensed from the first set 102 of the sensors 68 is outside the system-healthy data cluster 78. If the diagnostic algorithm 70 determines that the data sensed from the first set 102 of the plurality of sensors 68 is inside the system-healthy data cluster 78, generally indicated at 128 then the diagnostic algorithm 70 may indicate that the propulsion system 22 is healthy. If the overall health of the propulsion system 22 is healthy, then the diagnostic algorithm 70 may end, and perform no additional analysis of the propulsion system 22. The step of ending the diagnostic algorithm 70 is generally indicated by box 130 in FIG. 5. By doing so, the diagnostic algorithm 70 uses a top-down approach for diagnosing the propulsion system 22. If the overall health of the propulsion system 22 is determined to be healthy, there is no need to use additional computing power and resources to examine the remaining subsystems, component systems, and subcomponents of the propulsion system 22. This top-down diagnostic approach to the propulsion system 22 increases computational efficiency relative to a traditional bottom-up approach, which examines most of the subcomponents, component systems, and subsystems of the vehicle 20, regardless of whether or not the propulsion system 22 is operating properly, i.e., healthy. The diagnostic algorithm 70 described herein performs additional analyses when the propulsion system 22 is found to be unhealthy, not when it is found to be healthy.

If the diagnostic algorithm 70 determines that the data sensed from the first set 102 of the sensors 68 is outside the system-healthy data cluster 78, generally indicated at 132, then the diagnostic algorithm 70 may indicate that the propulsion system 22 is unhealthy. The diagnostic algorithm 70 may indicate that the propulsion system is unhealthy in a suitable manner, such as by lighting an indicator lamp, displaying a written message on a display screen, broadcasting an audio message, etc. When the overall health of the propulsion system 22 is determined to be unhealthy, then the diagnostic algorithm 70 further analyzes the propulsion system 22 using the top-down hierarchical examination procedure, in which the subsystems of the propulsion system 22 are analyzed at the first level 40 using selective data from the sensors 68 to identify one of the subsystems as an unhealthy subsystem, and then the component systems of the unhealthy subsystem are analyzed at the second level 50 using other selective data from the sensors 68 to identify one of the component systems as an unhealthy component system.

Additional examination levels may also be executed if needed. For example, subcomponents of the unhealthy component system may be analyzed at a third examination level using other selective data from the sensors 68 to identify one of the subcomponents of the unhealthy component system as an unhealthy subcomponent. It should be appreciated that the number of examination levels is dependent upon the specific configuration of the propulsion system 22. As such, the top-down hierarchical examination procedure described herein is not limited to the exemplary number of examination levels, and that the number of examination levels may be greater or fewer than the number of examination levels described herein.

Each examination level of the top-down hierarchical examination procedure includes a defined number of data inputs, i.e., a specific number of the sensors 68 providing data for each examination level, and a defined number of possible outputs. The possible outputs may be limited to either healthy or unhealthy for a specific subsystem or component system. However, in other embodiments, each level may include multiple data clusters, with each different data cluster used to identify a specific unhealthy feature of a subsystem or component system. For example, referring to FIG. 3, the first subsystem-unhealthy data cluster 80 is shown, along with a second subsystem-unhealthy data cluster 90, a third subsystem-unhealthy data cluster 92, and a fourth subsystem-unhealthy data cluster 94. The data sensed from the first set 102 of the sensors 68 is generally shown by the point 106. If the sensed data from the first set 102 of sensors 68 falls within the first subsystem-unhealthy data cluster 80, then the diagnostic algorithm 70 may determine that the first subsystem 42 is unhealthy, and conduct further analysis on the component systems of the first subsystem 42. However, if the sensed data from the first set 102 of sensors 68 falls within the second subsystem-unhealthy data cluster 90, then the diagnostic algorithm 70 may determine that the second subsystem 44 is unhealthy, and conduct further analysis on the component systems of the second subsystem 44. By so doing, the computational resources of the computing device 72 are directed to identifying the features of the propulsion system 22 that are unhealthy, instead of confirming the proper functionality of the other features of the propulsion system 22 that are healthy.

Referring to FIG. 3, when the overall health of the propulsion system 22 is determined to be unhealthy, then the diagnostic algorithm 70 compares the data sensed from the first set 102 of the sensors 68 to the first subsystem-unhealthy data cluster 80. The step of comparing the data from the first set 102 of the sensors 68 to the subsystem-unhealthy data clusters 80, 90, 92, 94 is generally indicated by box 134 in FIG. 5. The diagnostic algorithm 70 makes this comparison to determine if the data sensed from the first set 102 of the plurality of sensors 68 is within one of the subsystem-unhealthy data clusters 80, 90, 92, 94, or if the data sensed from the first set 102 of the plurality of sensors 68 is outside the subsystem-unhealthy data clusters 80, 90, 92, 94.

When the data sensed from the first set 102 of the sensors 68 is not inside the subsystem-unhealthy data clusters 80, 90, 92, 94, generally indicated at 136, then the diagnostic algorithm 70 may indicate that the propulsion system 22 is unhealthy, but the cause is not identifiable. The step of indicating that the cause of the unhealthy propulsion system 22 is not identifiable is generally indicated by box 138 in FIG. 5.

When the data sensed from the first set 102 of the sensors 68 is inside one of the subsystem-unhealthy data clusters 80, 90, 92, 94, generally indicated at 140, the diagnostic algorithm 70 may identify which one of the subsystems 42, 44, 46, 48 is the unhealthy subsystem. The step of identifying the unhealthy subsystem 42, 44, 46, 48 is generally indicated by box 142 in FIG. 5. The diagnostic algorithm 70 may indicate that the unhealthy subsystem in a suitable manner, such as by lighting an indicator lamp, displaying a written message on a display screen, broadcasting an audio message, etc. For example, if the data sensed from the first set 102 of the sensors 68 is inside the first subsystem-unhealthy data cluster 80, then the diagnostic algorithm 70 may indicate the first subsystem 42 is the unhealthy subsystem. It should be appreciated that the described analysis of the first subsystem 42 is exemplary, and that the diagnostic algorithm 70 may execute similar comparisons for the other subsystems of the propulsion system 22, e.g., compare the sensed data from the first set 102 of sensors 68 to the second subsystem-unhealthy data cluster 90 to determine if the second subsystem 44 is unhealthy, or compare the sensed data from the first set 102 of sensors 68 to the third subsystem-unhealthy data cluster 92 to determine if the third subsystem 46 is unhealthy, etc. By so doing, the diagnostic algorithm 70 may identify which one of the subsystems is unhealthy, and may be causing the propulsion system 22 to be unhealthy.

Once the diagnostic algorithm 70 determines which one of the subsystems of the propulsion system 22 is unhealthy, e.g., that the first subsystem 42 is unhealthy, then the diagnostic algorithm 70 analyzes the component systems of the unhealthy subsystem, e.g., the first component system 54, of the unhealthy first subsystem 42. The diagnostic algorithm 70 senses data from the second set 104 of the sensors 68. The step of sensing data from the second set 104 of the sensors 68 is generally indicated by box 143 in FIG. 5.

Referring to FIG. 4, the first component-unhealthy data cluster 82 is shown, along with a second component-unhealthy data cluster 96, a third component-unhealthy data cluster 98, and a fourth component-unhealthy data cluster 100. The data sensed from the second set 104 of the sensors 68 is generally shown by the point 108. If the sensed data from the second set 104 of sensors 68 falls within the first component-unhealthy data cluster 82, then the diagnostic algorithm 70 may determine that the first component system 54 is unhealthy, and conduct further analysis on the subcomponents of the first component system 54. However, if the sensed data from the second set 104 of sensors 68 falls within the second component-unhealthy data cluster 96, then the diagnostic algorithm 70 may determine that the second component system 56 is unhealthy, and conduct further analysis on the subcomponents of the second component system 56. By so doing, the computational resources of the computing device 72 are directed to identifying the features of the propulsion system 22 that are unhealthy, instead of confirming the proper functionality of the other features of the propulsion system 22 that are healthy.

Referring to FIG. 4, the diagnostic algorithm 70 compares the data sensed from the second set 104 of the sensors 68 to the component-unhealthy data clusters 82, 96, 98, 100, generally indicated by box 144 in FIG. 5. The diagnostic algorithm 70 makes this comparison to determine if the data sensed from the second set 104 of the sensors 68 is within one of the component-unhealthy data clusters 82 96, 98, 100, or if the data sensed from the second set 104 of the sensors 68 is outside the component-unhealthy data clusters 82, 96, 98, 100. If the diagnostic algorithm 70 determines that the data sensed from the second set 104 of the sensors 68 is inside of the first component-unhealthy data cluster 82, then the diagnostic algorithm 70 may indicate that the first component system 54 of the first subsystem 42 is the unhealthy component system. It should be appreciated that the described analysis of the first component system 54 is exemplary, and that the diagnostic algorithm 70 may execute similar comparisons for the other component systems of the first subsystem 42, e.g., compare the sensed data from the first set 102 of sensors 68 to the second component-unhealthy data cluster 96 to determine if the second component system 56 is unhealthy, or compare the sensed data from the first set 102 of sensors 68 to the third component-unhealthy data cluster 98 to determine if the third component system 58 is unhealthy, etc. By so doing, the diagnostic algorithm 70 may identify which one of the component systems of the first subsystem 42 is unhealthy, and may be causing the first subsystem 42 to be unhealthy.

If the diagnostic algorithm 70 determines that data sensed from the second set 104 of the sensors 68 is not within the component-unhealthy data clusters 82, 96, 98, 100, generally indicated at 146, then the diagnostic algorithm 70 may indicate that the cause of the unhealthy subsystem is not identifiable, generally indicated by box 148 in FIG. 5. If the diagnostic algorithm 70 determines that data sensed from the second set 104 of the sensors 68 is within one of the component-unhealthy data clusters 82, 96, 98, 100, generally indicated at 150, then the diagnostic algorithm 70 may identify the unhealthy component system of the unhealthy subsystem, generally indicated by box 152 in FIG. 5.

The diagnostic algorithm 70 may continue with the top-down hierarchical examination process in a like manner until the underlying cause of the unhealthy propulsion system 22 is identified. For example, the diagnostic algorithm 70 may determine that the overall health of the propulsion system 22 is unhealthy, determine that the internal combustion engine 24 is unhealthy at the first examination level, 40 determine that the intake air system 34 is unhealthy at the second examination level 50, and determine that the throttle actuator is unhealthy at the third level 52. The diagnostic algorithm 70 may then issue a message stating, for example, that “The vehicle 20 has a rough idle due to an engine misfire caused by an issue in the air delivery system associated with the throttle.” The diagnostic algorithm 70 may issue the message in a suitable manner, such as through a verbal announcement, a written message, and/or coded into memory 74 of the computing device 72 as an error code.

The process described herein improves the operating efficiency of the computing device 72 by using the top-down hierarchical examination process to focus the computational resources of the computing device 72 on locating the underlying fault in the propulsion system 22, instead of running bottom-up diagnostic tests that test functionally of the features of the propulsion system 22, even when they are operating properly. The top-down hierarchical examination process does not perform additional diagnostic tests on the subsystems and on the component systems of each of the subsystems, when the data sensed from the first set 102 of the sensors 68 indicates that the propulsion system 22 is healthy.

The diagnostic algorithm 84 described above may be realized and/or implemented using machine learning and/or artificial intelligence, such as but not limited to a neural network (e.g., deep convolutional recurrent neural network), a decision tree (e.g., random forest), etc. For example, a neural network may be trained with many labeled healthy data clusters, (e.g., data from various operations when the internal combustion engine is operating in a healthy state), and unhealthy data clusters (e.g., data representing faulty air flow when the internal combustion engine is operating in an unhealthy state that is induced by a possible air-related failure mode). In general, the input into the neural network may include the data from each selective set of sensors 68, and the output of the neural network may include the healthy/unhealthy state of the system, subsystem, or component, based on the training of the neural network. It should be appreciated that the use of a neural network to implement the logic of the above described diagnostic algorithm 84 is merely one exemplary way of implementing the logic of the diagnostic algorithm 84, and that the logic of the diagnostic algorithm 84 disclosed herein may be implemented on the computing device 72 in other ways.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of diagnosing a propulsion system of a vehicle, the method comprising:
defining a first set of a plurality of sensors of the vehicle for evaluating an overall status of the propulsion system;
defining a system-healthy data cluster, wherein the system-healthy data cluster defines an inclusive range of data values from the first set of the plurality of sensors indicating a healthy status of the propulsion system, and wherein the system-healthy data cluster is saved on a memory of a computing device of the vehicle;
sensing data from the first set of the plurality of sensors;
comparing the data sensed from the first set of the plurality of sensors to the system-healthy data cluster, with the computing device, to determine if the data sensed from the first set of the plurality of sensors is within the system-healthy data cluster, or if the data sensed from the first set of the plurality of sensors is at least partially outside the system-healthy data cluster;
indicating that the propulsion system is unhealthy, with the computing device, when the data sensed from the first set of the plurality of sensors is at least partially outside the system-healthy data cluster; and
analyzing the propulsion system using a top-down hierarchical examination procedure, with the computing device, when the propulsion system is unhealthy, in which a plurality of subsystems of the propulsion system are analyzed at a first examination level using selective data from the plurality of sensors to identify one of the plurality of subsystems as an unhealthy subsystem, and then a plurality of component systems of the unhealthy subsystem are analyzed at a second examination level using other selective data from the plurality of sensors to identify one of the plurality of component systems as an unhealthy component system.

2. The method set forth in claim 1, wherein the plurality of subsystems of the propulsion system includes a first subsystem, and wherein analyzing the propulsion system using the top-down hierarchical examination procedure includes determining if the first subsystem of the propulsion system is the unhealthy subsystem, with the computing device, based on the data sensed from the first set of the plurality of sensors.

3. The method set forth in claim 2, further comprising defining a first subsystem-status data cluster for the first subsystem, wherein the first subsystem-status data cluster defines a range of data values from the first set of the plurality of sensors indicating that the first subsystem is the unhealthy subsystem, and wherein the first subsystem-status data cluster is saved on the memory of the computing device.

4. The method set forth in claim 3, wherein determining if the first subsystem is the unhealthy subsystem includes comparing the data sensed from the first set of the plurality of sensors to the first subsystem-status data cluster, with the computing device, to determine if the data sensed from the first set of the plurality of sensors is within the first subsystem-status data cluster, or if the data sensed from the first set of the plurality of sensors is outside the first subsystem-status data cluster.

5. The method set forth in claim 4, further comprising indicating that the first subsystem is the unhealthy subsystem, with the computing device, when the data sensed from the first set of the plurality of sensors is inside of the first subsystem-status data cluster.

6. The method set forth in claim 5, wherein the plurality of component systems of the first subsystem includes a first component system, and wherein the method further comprises defining a first component-status data cluster for the first component system of the first subsystem, wherein the first component-status data cluster defines a range of data values from a second set of the plurality of sensors indicating that the first component system of the first subsystem is the unhealthy component, and wherein the first component-status data cluster is saved on the memory of the computing device.

7. The method set forth in claim 6, further comprising comparing the data sensed from the second set of the plurality of sensors to the first component-status data cluster, with the computing device, to determine if the data sensed from the second set of the plurality of sensors is within the first component-status data cluster, or if the data sensed from the second set of the plurality of sensors is outside the first component-status data cluster, when the first system is un-healthy.

8. The method set forth in claim 7, further comprising indicating that the first component system of the first subsystem is the unhealthy component system, with the computing device, when the data sensed from the second set of the plurality of sensors is inside of the first component-status data cluster.

9. The method set forth in claim 1, characterized by not performing additional diagnostic tests on the plurality of subsystems and on the plurality of component systems of each of the plurality of subsystems, when the data sensed from the first set of the plurality of sensors is inside the system-healthy data cluster.

10. The method set forth in claim 1, further comprising manipulating the data sensed from the first set of the plurality of sensors to define a data value, and using the data value to compare to the system-healthy data cluster to determine if the data sensed from the first set of the plurality of sensors is within the system-healthy data cluster, or if the data sensed from the first set of the plurality of sensors is outside the system-healthy data cluster.

11. The method set forth in claim 1, further comprising communicating data from the computing device of the vehicle to a computer located remotely from the vehicle, wherein the computer located remotely from the vehicle implements at least a portion of the top-down hierarchical examination procedure.

12. A diagnostic system for diagnosing a propulsion system of a vehicle, the diagnostic system comprising:
a plurality of sensors operable to sense data related to operation of the propulsion system;
a computing device in communication with the plurality of sensors, the computing device including a processor and a memory having a system-healthy data cluster, and a diagnostic algorithm stored thereon, wherein the processor is operable to execute the diagnostic algorithm to:
sense data from a first set of the plurality of sensors;
compare the data sensed from the first set of the plurality of sensors to the system-healthy data cluster to determine if the data sensed from the first set of the plurality of sensors is within the system-healthy data cluster, or if the data sensed from the first set of the plurality of sensors is at least partially outside the system-healthy data cluster, wherein the system-healthy data cluster defines an inclusive range of data values from the first set of the plurality of sensors indicating a healthy status of the propulsion system;
indicate that the propulsion system is unhealthy when the data sensed from the first set of the plurality of sensors is at least partially outside the system-healthy data cluster; and
analyze the propulsion system using a top-down hierarchical examination procedure when the propulsion system is unhealthy, in which a plurality of subsystems of the propulsion system are analyzed at a first examination level using selective data from the plurality of sensors to identify one of the plurality of subsystems as an unhealthy subsystem, and then a plurality of component systems of the unhealthy subsystem are analyzed at a second examination level using other selective data from the plurality of sensors to identify one of the plurality of component systems as an unhealthy component system.

13. The diagnostic system set forth in claim 12, further comprising a first subsystem-status data cluster saved on the memory of the computing device, wherein the first subsystem-status data cluster defines a range of data values from the first set of the plurality of sensors indicating that a first subsystem of the propulsion system is the unhealthy subsystem.

14. The diagnostic system set forth in claim 13, wherein the processor is operable to execute the diagnostic algorithm to compare data sensed from the first set of the plurality of sensors to the first subsystem-status data cluster to determine if the data sensed from the first set of the plurality of sensors is within the first subsystem-status data cluster, or if the data sensed from the first set of the plurality of sensors is outside the first subsystem-status data cluster.

15. The diagnostic system set forth in claim 14, wherein the processor is operable to execute the diagnostic algorithm to indicate that the first subsystem is the unhealthy subsystem when the data sensed from the first set of the plurality of sensors is inside of the first subsystem-status data cluster.

16. The diagnostic system set forth in claim 15, further comprising a first component-status data cluster saved on the memory of the computing device, wherein the first component-status data cluster defines a range of data values from a second set of the plurality of sensors indicating that a first component system of the first subsystem is the unhealthy component system.

17. The diagnostic system set forth in claim 16, wherein the processor is operable to execute the diagnostic algorithm to compare data sensed from the second set of the plurality of sensors to the first component-status data cluster, when the first subsystem is the unhealthy subsystem, to determine if the data sensed from the second set of the plurality of sensors is within the first component-status data cluster, or if the data sensed from the second set of the plurality of sensors is outside the first component-status data cluster.

18. The diagnostic system set forth in claim 17, wherein the processor is operable to indicate that the first component system of the first subsystem is the unhealthy component system when the data sensed from the second set of the plurality of sensors is inside of the first component-status data cluster.

19. A vehicle comprising:
a propulsion system having a plurality of subsystems, with each of the plurality of subsystems having a plurality of components;
a plurality of sensors operable to sense data related to operation of the propulsion system;
a diagnostic system disposed in communication with the plurality of sensors and operable to receive data from the plurality of sensors, wherein the diagnostic system includes a processor and a memory having a system-healthy data cluster, and a diagnostic algorithm stored thereon, wherein the processor is operable to execute the diagnostic algorithm to:
sense data from a first set of the plurality of sensors;
compare the data sensed from the first set of the plurality of sensors to the system-healthy data cluster to determine if the data sensed from the first set of the plurality of sensors is within the system-healthy data cluster, or if the data sensed from the first set of the plurality of sensors is at least partially outside the system-healthy data cluster, wherein the system-healthy data cluster defines an inclusive range of data values from the first set of the plurality of sensors indicating a healthy status of the propulsion system;
indicate that the propulsion system is unhealthy when the data sensed from the first set of the plurality of sensors is at least partially outside the system-healthy data cluster; and
analyze the propulsion system using a top-down hierarchical examination procedure when the propulsion system is unhealthy, in which a plurality of subsystems of the propulsion system are analyzed at a first examination level using selective data from the plurality of sensors to identify one of the plurality of subsystems as an unhealthy subsystem, and then a plurality of component systems of the unhealthy subsystem are analyzed at a second examination level using other selective data from the plurality of sensors to identify one of the plurality of component systems as an unhealthy component system.

20. The vehicle set forth in claim 19, further comprising:
a first subsystem-status data cluster saved on the memory of the computing device, wherein the first subsystem-status data cluster defines a range of data values from the first set of the plurality of sensors indicating that a first subsystem of the propulsion system is the unhealthy subsystem;
wherein the processor is operable to execute the diagnostic algorithm to compare data sensed from the first set of the plurality of sensors to the first subsystem-status data cluster to determine if the data sensed from the first set of the plurality of sensors is within the first subsystem-status data cluster, or if the data sensed from the first set of the plurality of sensors is outside the first subsystem-status data cluster;
wherein the processor is operable to execute the diagnostic algorithm to indicate that the first subsystem is the unhealthy subsystem when the data sensed from the first set of the plurality of sensors is inside of the first subsystem-status data cluster;
a first component-status data cluster saved on the memory of the computing device, wherein the first component-status data cluster defines a range of data values from a second set of the plurality of sensors indicating that a first component system of the first subsystem is the unhealthy component system;
wherein the processor is operable to execute the diagnostic algorithm to compare data sensed from the second set of the plurality of sensors to the first component-status data cluster, when the first subsystem is the unhealthy subsystem, to determine if the data sensed from the second set of the plurality of sensors is within the first component-status data cluster, or if the data sensed from the second set of the plurality of sensors is outside the first component-status data cluster; and
wherein the processor is operable to execute the diagnostic algorithm to indicate that the first component system of the first subsystem is the unhealthy component system when the data sensed from the second set of the plurality of sensors is inside of the first component-status data cluster.
